(19) United States
(12) Patent Application Publication
(10) Pub. No.: US 2018/0245643 A1
(43) Pub. Date: Aug. 30, 2018

(54) ELASTIC RETURN DEVICE FOR A WET CLUTCH MECHANISM AND WET CLUTCH COMPRISING SUCH AN ELASTIC RETURN DEVICE

(71) Applicant: VALEO EMBRAYAGES, Amiens Cedex 2 (FR)

(72) Inventors: Laurent CAUMARTIN, Amiens (FR); Rabah ARHAB, Amiens (FR); Herve RIBOT, Amiens (FR); Guillaume VUAROQUEAUX, Amiens (FR); David DELPLACE, Amiens (FR)

(73) Assignee: VALEO EMBRAYAGES, Amiens Cedex 2 (FR)

(21) Appl. No.: 15/906,801

(22) Filed: Feb. 27, 2018

(30) Foreign Application Priority Data
Feb. 28, 2017 (FR) 17 51607

(51) Int. Cl. F16D 25/0638; F16D 23/14; F16D 25/12

(52) U.S. Cl. CPC F16D 25/0638; F16D 2127/02; F16D 25/12; F16D 23/14

(57) ABSTRACT

An elastic return device including a gasket and a clutch mechanism whose actuating system includes a control chamber designed to receive a pressurized fluid, a piston which is axially movable in the control chamber so as to engage or disengage the corresponding clutch, a balancing chamber situated opposite the control chamber in relation to the piston, and an elastic return device housed in the balancing chamber and designed to exert an axial force against the piston. According to the invention, the elastic return device includes, on one of its faces bearing against the piston, an internal peripheral end which extends radially beneath the piston and which carries a gasket in order to seal off the balancing chamber from the control chamber. The invention likewise relates to a transmission system including such a dual clutch mechanism.

### TECHNICAL FIELD

The present invention relates to an elastic return device able to generate a force opposing an element making possible the engaging or disengaging of a clutch of a wet-type clutch mechanism as is used in the automotive field. The invention also relates to a clutch mechanism comprising such an elastic return device, as well as a transmission system integrating such a clutch mechanism.

### PRIOR ART

Clutch mechanisms are known which comprise a clutch in rotation about an axis of rotation and a force generator devised to configure the clutch in a so-called disengaged or engaged configuration by means of a movable piece, known as a piston, making it possible to transmit the force generated in the area of the force generator to said clutch.

As is known, an actuating system may be formed by a hydraulic force generator comprising (i) a control chamber designed to receive a pressurized fluid, (ii) a piston which is axially movable in the control chamber and extending radially outside the control chamber in order to engage or disengage the clutch, (iii) a balancing chamber situated opposite the control chamber in relation to the piston, the balancing chamber comprising an elastic return device able to generate a so-called return force opposing the piston.

The control chamber is fed with a pressurized hydraulic fluid in order to enable the movement of the piston between a first position corresponding to an engaged configuration of the clutch and a second position corresponding to a disengaged configuration of the clutch. In order to do this, the pressurized hydraulic fluid is routed to the control chamber by means of so-called high-pressure fluid lines.

On the contrary, the balancing chamber is fed with a so-called cooling hydraulic fluid making it possible to lubricate the components of the clutch mechanism, and also the balancing chamber. In order to do this, the cooling hydraulic fluid is routed in particular to the balancing chamber by means of so-called low-pressure fluid lines.

As is known, the pressure of the cooling hydraulic fluid needed for the lubrication of the clutch mechanism is less than that of the pressurized hydraulic fluid needed to generate the force making it possible to place the clutch in one or other of the aforementioned configurations.

Moreover, the piston of the clutch mechanism being situated in an intermediate position between the balancing chamber and the control chamber, it thus bounds the two chambers of the clutch mechanism. It is thus necessary to ensure the tightness between the balancing chamber and the control chamber in the area of the piston in order to guarantee on the one hand the pressurizing of the control chamber, and on the other hand the lubricating of the balancing chamber, preferably with no leakage between the two chambers.

As is known, the tightness between the two chambers has been realized thus far by a gasket located at one internal radial end of the piston, the gasket being press-fitted against a clutch support radially bounding on the inside both the control chamber and the balancing chamber. Such a configuration is known from document DE 10 2014 102 515 A1.

One drawback associated with this configuration involves the complex fabrication of the piston, which is produced for example by stamping and many machining repetitions in order to adapt said piston to the different clutch mechanisms. In fact, the piston is an adjustment piece which is machined in dependence on the other pieces making up the clutch mechanism and the mechanical characteristics of said clutch mechanism. In general, the piston is a stamped sheet metal piece which applies an axial force to a stack of frictional elements in order to transmit a motor torque within the clutch. For example, the torque to be transmitted in the area of the clutch constrains and defines in particular the number of frictional elements making up said clutch. Consequently, the torque to be transmitted in the area of the clutch also constrains an axial extension of the piston so as to allow it to couple or uncouple the frictional elements with/from each other, while maintaining as constant as possible an axial and/or radial footprint of the clutch mechanism, despite the variability of the torques transmitted. Thus, the larger the torque to be transmitted, the larger the number of frictional elements, and it is thus advisable to reduce the axial extension of the piston in order to allow for the dimensional variations of the clutch which are intrinsic to its mechanical characteristics. Hence, the piston is a piece whose geometry is difficult to standardize for several applications of clutch mechanisms and/or several geometries.

The inserting of a gasket at an internal radial end of the piston of a clutch mechanism thus takes place in a complex industrialization context, and it would appear to be necessary to simplify the fabrication process in order to better control the tightness in the area of the pressure and balancing chambers on the one hand, and on the other hand to reduce the costs of fabrication. This is all the more critical when the gasket is obtained by ovemmoulding directly on the piston: this vulcanization process is generally realized by an outside subcontractor, which adds to the complexity of industrialization.

The purpose of the present invention is to overcome at least in large measure the above problems and also to provide other advantages by proposing a new elastic return device and a new clutch mechanism to solve at least one of these problems.

Another goal of the present invention is to propose a new elastic return device able to ensure the tightness between a balancing chamber and a control chamber of a clutch mechanism when said elastic return device is mounted on said clutch mechanism.

### SUMMARY OF THE INVENTION

According to a first aspect of the invention, one accomplishes at least one of the aforesaid objectives with an elastic return device for a wet clutch mechanism, said elastic return device being designed to generate a force opposing a piston placed in movement by an actuating system of a clutch of the clutch mechanism, said elastic return device comprising:
a first annular piece designed to bear against a support face of the clutch mechanism;
a second annular piece designed to bear against the piston of the clutch mechanism;
a plurality of elastic elements extending between the first annular piece and the second annular piece;
   the second annular piece comprising at its internal peripheral end a gasket, and the second annular piece bearing against a face of the piston oriented axially opposite the plurality of elastic elements.

In an ingenious manner, the elastic return device according to the first aspect of the invention makes it possible to facilitate the fabrication processes of the clutch mechanism on which said elastic return device is designed to be mounted. Unlike the industrial context described for the prior art, such an elastic return device forms an independent module which is easier to manipulate and insert on the clutch mechanism than the manipulation and the insertion of the gasket at one end of the piston. The gasket is preassembled on the module formed by the elastic return device.

The elastic return device is configured to generate a force opposing a force exerted on the second annular piece thereof. In particular, the elastic return device is configured to generate a force substantially perpendicular to the second annular piece when a force substantially perpendicular to said second annular piece is applied to the elastic return device. The positioning of the gasket on the internal peripheral end of the second annular piece ensures a precise positioning of the gasket in relation to the face of the piston which is oriented axially opposite the plurality of elastic elements.

The advantageous configuration of the second annular piece with respect to the support face of the piston makes it possible to assemble the elastic return device according to the first aspect of the invention more easily on the clutch mechanism and to prevent the second annular piece from becoming loosened from the piston against which it is applied under the influence of the force generated axially by the plurality of elastic elements.

In its first aspect, the invention addresses all the embodiments of such an elastic return device. Certain embodiments shall be described more precisely, especially in the particular context of an implementation on a clutch mechanism. In fact, in a general but not limiting fashion, the elastic return device according to the first aspect of the invention is designed to be housed in a balancing chamber of an actuating system of the clutch mechanism.

The elastic return device according to the first aspect of the invention may advantageously comprise at least one of the following modifications, the technical characteristics forming these modifications being able to be taken alone or in combination:
the internal peripheral end of the second annular piece is formed by an angled end portion, such that the gasket extends onto the angled end portion of the second annular piece of the elastic return device. The angled end portion is advantageously designed to be inserted near the piston of the clutch mechanism with which the elastic return device may cooperate in order to improve the tightness of the control chamber of said clutch mechanism bounded by said piston. In particular, but in a nonlimiting manner, the angled portion may extend substantially perpendicular to the second annular piece of the elastic return device, and in particular substantially parallel to an axis of symmetry of said second annular piece;
the gasket is fitted onto the internal peripheral end of the second annular piece. The gasket thus forms a jacketing of at least the internal peripheral end of the second annular piece of the elastic return device;
the gasket extends along a radial elongation edge of the second annular piece. In other words, the gasket extends radially toward the outside beyond the internal peripheral end of the second annular piece. This advantageous configuration allows the use of a gasket of larger dimension, covering both the internal end and the adjacent radial elongation edge of the second annular piece of the elastic return device, in order to increase the surface of said gasket, which can be placed bearing against an opposite face, and to thus improve its fixation on the second annular piece of said elastic return device;
the gasket comprises a first seal and a second seal, the second seal extending radially beyond the first seal on the second annular piece. Each seal of the gasket is situated against an opposite face of the second annular piece of the elastic element, thus forming an exterior jacketing of a portion of said second annular piece. In other words, the portion of the second annular piece of the elastic return device is situated in the gasket, between the first and second seals;
the gasket is vulcanized in order to make it more elastic. In particular, the gasket of the elastic return device is obtained by an overmoulding process, such as a vulcanization process. The gasket is glued to or overmoulded or vulcanized on the internal peripheral end of the second annular piece;
the gasket has a lip. The lip extends projecting with respect to the first and/or the second seal of the gasket. The lip enables better control of the bearing of the gasket against a face opposite said lip. The lip also allows for improved tightness when there is a relative movement between the gasket and the opposite face, especially of the clutch mechanism, against which it is bearing. The lip extends axially in a direction opposite the first annular piece, advantageously beyond the second annular piece;
the elastic return device according to the first aspect of the invention comprises a centring means designed to cooperate with a complementary centring means of the piston in order to accomplish a centring of the elastic return device with respect to said piston. According to a first alternative, the centring means takes the form of at least one cylindrical span of axial extension forming a radial shoulder surface substantially parallel to an axis of symmetry of the elastic return device. According to a second alternative, the centring means takes the form of at least one axial opening devised in the second annular piece;
the elastic return device according to the first aspect of the invention comprises a fixation means designed to secure the elastic return device to the piston of the clutch mechanism. According to a first alternative, the fixation means takes the form of a first ratcheting means designed to cooperate with a complementary ratcheting means situated on the piston. According to a second alternative, the fixation means takes the form of an axial opening devised in the second annular piece. According to a third alternative, the fixation means takes the form of a rivet, preferably an extruded one;
the fixation means is of the detachable type;
when the elastic return device according to the first aspect of the invention comprises both a centring means and a fixation means, the centring means is the fixation means. In other words, the centring means and the fixation means are merged with each other;
the angled end portion of the second annular piece extends axially in a direction opposite that of the first annular piece;
the plurality of elastic elements is of the helicoidal spring type.

According to a second aspect, the invention also relates to a clutch mechanism designed to be installed between a motor and a transmission of a vehicle, said clutch mechanism comprising:
a clutch in rotation about an axis of rotation;
an actuating system designed to engage or disengage the clutch, said actuating system comprising:
   a control chamber designed to receive a pressurized fluid;
   a balancing chamber bounded in part by a piston, the piston being axially movable and radially bounding the control chamber toward the outside by an axial extension span, said piston extending radially to the outside from said control chamber in order to engage or disengage the clutch under the effect of the pressurized fluid contained in the control chamber;
   an elastic return device according to the first aspect of the invention or according to any one of its modifications, said elastic return device being housed in the balancing chamber and extending between the piston and a lateral face of the balancing chamber of the clutch mechanism.

According to its second aspect, the invention thus proposes a clutch mechanism in which the tightness of the balancing chamber is ensured by the elastic return device according to the first aspect of the invention. This advantageous configuration makes it possible to simplify the processes of industrialization of such a clutch mechanism and, consequently, to reduce the costs of fabrication.

In the rest of the description and in the claims, we shall use, in a nonlimiting fashion and in order to facilitate the understanding thereof, the terms:
“front” or “rear” according to the direction with respect to an axial orientation dictated by the principal axis O of rotation of the transmission system, “the rear” denoting the portion situated to the right of the figures, on the transmission side, and “the front” denoting the left-hand portion of the figures, on the motor side; and
“interior/internal” or “exterior/external” with respect to the axis O and along a radial orientation, orthogonal to said axial orientation, “the interior” denoting a proximal portion of the axis O and “the exterior” denoting a distal portion of from the axis O.

The clutch mechanism according to the second aspect of the invention may advantageously comprise at least one of the following modifications, the technical characteristics forming these modifications being able to be taken alone or in combination:
the balancing chamber is situated opposite the control chamber with respect to the piston;
the elastic return device is distinct from the piston;
the angled end portion of the elastic return device extends in a radial direction, said angled end portion being situated radially between an internal end of the piston and a support hub of the clutch mechanism. This ingenious configuration makes it possible to intercalate the gasket, located in particular on the angled end portion of the elastic return device, between the piston and the support hub;
the gasket of the elastic return device is at least partly bearing against the support hub and against the piston;
the gasket is axially prestressed between the second annular piece and the piston;
the gasket of the elastic return device is simultaneously bearing radially against the support hub and bearing axially against the piston. By bearing radially what is meant is that the gasket of the elastic return device is bearing against a circumferential portion against the support hub;
in the area of the radial elongation edge of the second annular piece of the elastic return device, the second seal of the gasket is interposed between said second annular piece and the piston of the clutch mechanism;
an axial space is formed between the piston and the second annular piece of the elastic return device, along which piece the second seal of the gasket extends, the axial space, taken along a radial direction, being less than or equal to the thickness of the second seal of the gasket. This advantageous configuration makes it possible to achieve a clamping of the second seal against the piston in order to improve the firmness of the gasket on the elastic return device, on the one hand, and on the other hand to improve the tightness between the piston and said elastic return device, and consequently to improve the tightness of the control chamber. According to a first variant embodiment, the axial space is formed on a portion of the piston situated opposite the second annular piece of the elastic return device along which piece the second seal of the gasket extends. According to a second variant embodiment, the axial space is formed at a zone of the second annular piece of the elastic return device along which piece the second seal of the gasket extends, said zone being situated opposite the piston;
the gasket of the elastic return device bears against the support hub in the area of the first seal of said gasket;
the lip of the gasket of the elastic return device is situated at an axial end of said gasket, the lip bearing against the support hub of the clutch mechanism;
there is a radial play between the second seal of the gasket of the elastic return device and an internal radial end of the piston;
the elastic return device of the clutch mechanism comprises a centring means cooperating with a complementary centring means of the piston in order to accomplish a centring of said elastic return device with respect to said piston. According to a first alternative, the centring means takes the form of a cylindrical span of axial extension forming a radial shoulder surface substantially parallel to an axis of symmetry of the elastic return device. According to a second alternative, the centring means takes the form of an axial opening devised in the second annular piece;
the elastic return device of the clutch mechanism comprises a fixation means securing the elastic return device to the piston of the clutch mechanism. According to a first alternative, the fixation means takes the form of a first ratcheting means designed to cooperate with a complementary ratcheting means situated on the piston. According to a second alternative, the fixation means takes the form of an axial opening devised in the second annular piece. According to a third alternative, the fixation means takes the form of a rivet, preferably an extruded one;
the fixation means is of the detachable type;
when the elastic return device comprises both a centring means and a fixation means, the centring means is the fixation means. In other words, the centring means and the fixation means are merged with each other;
the elastic return device comprises a means of centring the elastic return device formed by at least one axial opening cooperating with at least one complementary cylindrical span of axial extension, formed on a face of the piston opposite the elastic return device;
the lateral face of the balancing chamber against which the elastic return device bears is formed by a face of an entrance disc holder of the clutch mechanism situated opposite the piston;
the clutch mechanism according to the second aspect of the invention is of the multiple-disc type;
according to a preferred embodiment, the clutch mechanism according to the second aspect of the invention is of the dual clutch type comprising a first clutch driven by a first actuating system and a second clutch driven by a second actuating system. According to a first variant, the first and second clutches arc disposed radially, the second clutch being situated radially inside the first clutch. According to a second variant embodiment, the first and second clutches are disposed axially, the second clutch being situated axially behind the first clutch.

According to a third aspect of the invention, there is proposed a transmission system for an automobile comprising a clutch mechanism according to the second aspect of the invention or to any one of its modifications and in which the clutch is coupled in rotation to:
an output shaft of the transmission by means of an entrance disc holder; and
an entrance web, said entrance web being coupled in rotation to an input shaft driven in rotation by at least one crank shaft of a motor.

According to a preferred variant embodiment, there is proposed a transmission system for an automobile comprising a dual clutch mechanism according to the second aspect of the invention and according to its preferred embodiment and in which:
the first clutch is coupled in rotation to a first output shaft of the transmission by means of a first entrance disc holder,
the second clutch is coupled in rotation to a second output shaft of the transmission by means of a second entrance disc holder,
the first and the second clutches are alternatively coupled in rotation to an entrance web, said entrance web being coupled in rotation to an input shaft driven in rotation by at least one crank shaft.

Different embodiments of the invention are provided, integrating by the set of their possible combinations the different optional characteristics set forth here.

### DESCRIPTION OF THE FIGURES

Other characteristics and advantages of the invention will emerge further in the course of the following description, on the one hand, and from several exemplary embodiments given by way of indication and not limitation, making reference to the enclosed schematic drawings, on the other hand, in which:

FIG. 1 illustrates a perspective partially sectioned view of an elastic return device according to the first aspect of the invention;

FIG. 2 illustrates an axial cross-sectional view of an exemplary embodiment of a clutch mechanism according to the second aspect of the invention;

FIG. 3 illustrates a detailed view of the actuating systems of the clutch mechanism of FIG. 2

FIG. 4 illustrates a perspective partially sectioned view of the clutch mechanism shown in FIG. 2;

FIG. 5 illustrates a front view of an elastic return device mounted on a piston, seen from a balancing chamber of the clutch mechanism shown in FIG. 2;

FIG. 6A illustrates an axial cross-sectional view along the sectioning axis PP represented in FIG. 5;

FIG. 6B illustrates the detailed view Q as represented in FIG. 6A.

Of course, the characteristics, the variants and the different embodiments of the invention may be associated with each other, according to different combinations, as long as they are not mutually incompatible or exclusive. In particular, one may conceive of variants of the invention having only a selection of characteristics described in the following, isolated from the other characteristics described, if this selection of characteristics is sufficient to provide a technical advantage or to differentiate the invention with respect to the prior art.

In particular, all the variants and all the embodiments described may be combined with each other, if nothing prevents this in a technical respect.

In the figures, the elements which are common to several figures retain the same references.

### DETAILED DESCRIPTION OF THE INVENTION

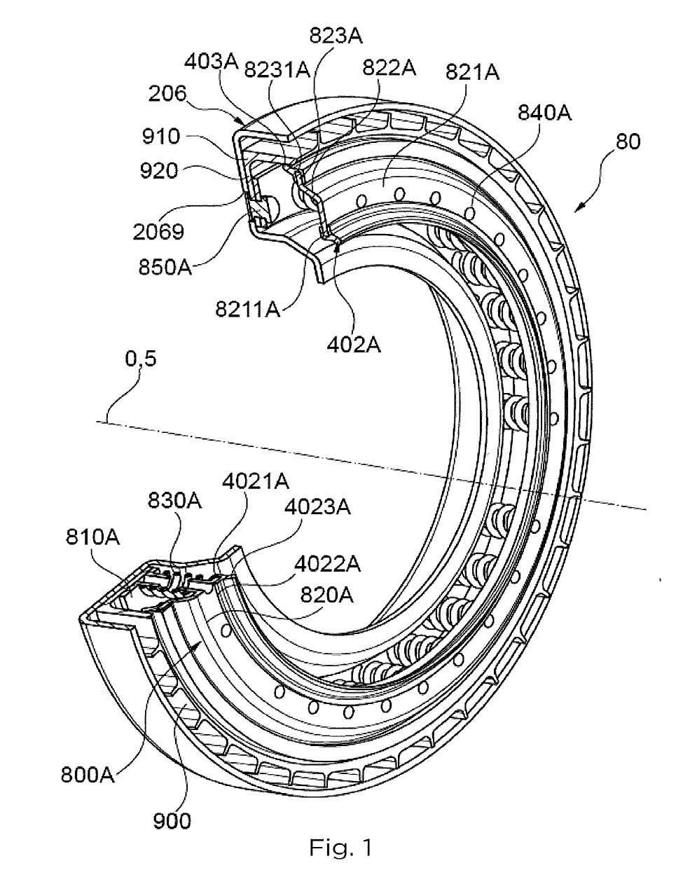

Referring to FIG. 1, an exemplary embodiment of an elastic return device 800 according to the first aspect of the invention is represented. Such an elastic return device 800 is configured to be able to generate a force opposing a piston 105, 205 placed in movement by an actuating system 300 of a clutch 100, 200 of a clutch mechanism. For this purpose, the elastic return device 800 comprises:
a first annular piece 810A designed to bear against a support face of the clutch mechanism;
a second annular piece 820A designed to bear against the piston 105, 205 of the clutch mechanism;
a plurality of elastic elements 830A extending between the first annular piece 810A and the second annular piece 820A. In the example illustrated in FIG. 1, the plurality of elastic elements 830A is of the helicoidal spring type, said helicoidal springs being distributed at regular angles about an axis of symmetry S of the elastic return device 800.

In particular, the second annular piece 820A of the elastic return device 800 comprises at its internal peripheral end 8211A a gasket 402A, known as the second gasket 402A. The gasket 402A extends axially in a direction opposite the first annular piece 810A with respect to the second annular piece 820A.

The second annular piece 820 of the elastic return device 800 has an axis of symmetry S. According to the invention, the second annular piece 820 bears against a face of the corresponding piston 105, 205, said face being oriented axially opposite the plurality of elastic elements 830. In the exemplary embodiment illustrated in FIG. 1, the second annular piece 820A is formed by a radial elongation edge 821A which extends from the internal peripheral end 8211A to a slanting intermediate span 822A. The slanting intermediate span 822A is prolonged radially toward the outside by an external radial extension span 823A which carries, in the area of its external end 8231A, another gasket 403A, known as the third gasket 403A.

In the exemplary embodiment illustrated in FIG. 1, the internal peripheral end 8211A of the second annular piece 820A of the elastic return device 800 is situated in the radial prolongation of the radial elongation edge 821A of said second annular piece 820A. Alternatively, the internal peripheral end 8211A of the second annular piece 820A may be formed by an angled end portion which preferably extends axially in a direction opposite that of the first annular piece 810A.

The second annular piece 820A also comprises a plurality of openings 860A distributed at regular angles about the axis of symmetry S. The openings 860A form holes passing through the second annular piece 820A. The openings 860A arc designed to enable a centring and/or a fixation of the elastic return device on the corresponding piston of the clutch mechanism.

The second gasket 402A is advantageously formed by a first seal 4021A situated axially on the side of the first annular piece 810A in relation to the second annular piece 820A, and a second seal 4022A which is situated on the side opposite the first annular piece 810A in relation to the second annular piece 820A. Thus, the second gasket 402A is firmly secured to the second annular piece 820A, more particularly in the area of its internal peripheral end 8211A, for example by press fitting.

In an advantageous manner, the second seal 4022A of the second gasket 402A extends on the radial elongation edge 821A of the second annular piece 820A, radially beyond the first seal 4021A.

In the exemplary embodiment illustrated in FIG. 1, the second gasket 402A has a lip 4023 which extends simultaneously radially inside the internal peripheral end 8211A of the second annular piece 820A and axially in a direction opposite the first annular piece 810A in relation to the second annular piece 820A.

The elastic return device 800 advantageously comprises a diameter reducer 900 having a cylindrical span 910 and a radial span 920. The cylindrical span 910 is in radial contact against a bearing piece of the clutch mechanism, such as a second exit disc holder 206 as represented in FIG. 1. The radial span 920 of the diameter reducer 900 is advantageously intercalated between the first annular piece 810A and the bearing piece of the clutch mechanism. More particularly, the radial span 920 of the diameter reducer 900 bears axially against the first annular piece 810A.

In an advantageous manner, the elastic return device 800 also comprises fixation means 850A for fixing the diameter reducer 900 on the first annular piece 810A. In the example illustrated in FIG. 1, the fixation means 850A are of the type of at least one rivet distributed at regular angles about the axis of symmetry S. Preferably, the bearing piece of the clutch mechanism contains an opening 2069 situated opposite the fixation means 850 of the elastic return device 800.

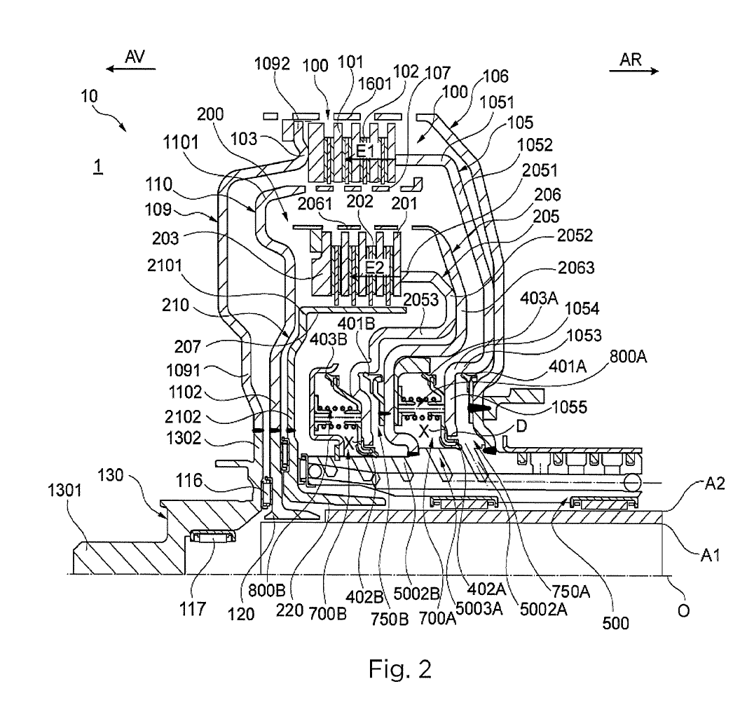

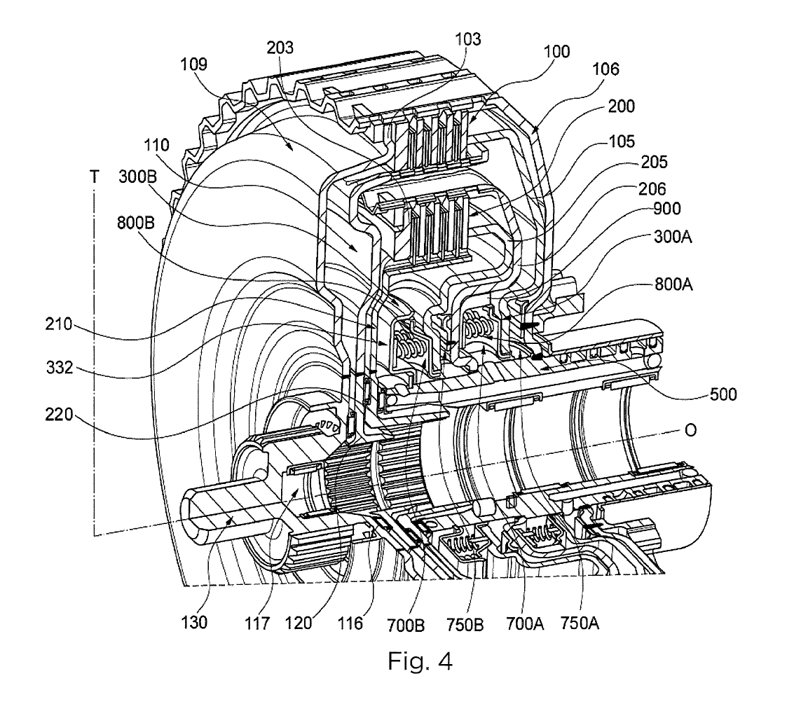

Making reference to FIGS. 2 to 4, the illustrated exemplary embodiment of the clutch mechanism 10 according to the second aspect of the invention is preferably of the dual wet clutch type, and even more preferably in a so-called radial position, the first clutch 100 being situated outside the second clutch 200. Alternatively, the dual clutch mechanism 10 may be in a so-called axial configuration, the first clutch 100 being situated in front AV of the second clutch 200. Of course, the invention according to its second aspect is not limited to dual clutch mechanisms 10, but also includes single wet clutch mechanisms.

The dual clutch mechanism 10 is integrated in a transmission train 1 comprising a transmission coupled in rotation to the clutch mechanism 100.

In a general fashion, the dual clutch mechanism 10 is designed so that it can couple an input shaft, not shown, in rotation to a first transmission shaft A1 or alternatively to a second transmission shaft A2 by means of the first clutch 100 or the second clutch 200, respectively.

In the context of the invention, the input shaft is driven in rotation by at least one crank shaft of a motor, such as a thermal motor; and the first and second transmission shafts A1, A2 are coaxial and designed to be coupled in rotation to the transmission, such as a gear box of the type used in automobiles.

As illustrated in FIGS. 2 to 4, the first clutch 100 and the second clutch 200 are advantageously of the multiple disc type. Each multiple-disc clutch comprises, on the one hand, a plurality of first friction elements 101, 201, such as flanges, joined firmly in rotation to the input shaft, and on the other hand a plurality of second friction elements 102, 202, such as friction discs, joined thinly in rotation to at least one of the transmission shafts A1, A2.

The first transmission shaft A1 is coupled in rotation to the input shaft and driven by it in rotation when the first clutch 100 is placed in a so-called engaged position for which the plurality of first friction elements 101 is coupled in rotation to the plurality of second friction elements 102. Alternatively, the first transmission shaft A1 is decoupled in rotation from the input shaft when the first clutch 100 is placed in a so-called disengaged position for which the plurality of first friction elements 101 is decoupled in rotation from the plurality of second friction elements 102.

In an analogous manner, the second transmission shaft A2 is coupled in rotation to the input shaft and driven by it in rotation when the second clutch 200 is placed in an engaged position for which the plurality of first friction elements 201 is coupled in rotation to the plurality of second friction elements 202. Alternatively, the second transmission shaft A2 is decoupled in rotation from the input shaft when the second clutch 200 is placed in a so-called disengaged position for which the plurality of first friction elements 201 is decoupled in rotation from the plurality of second friction elements 202.

The first clutch 100 and the second clutch 200 are designed to transmit in alternation a so-called input power—a torque and a speed of rotation—from the input shaft to one of the two transmission shafts A1, A2, as a function of the respective configuration of each clutch 100 and 200 and by means of an entrance web 109.

The first clutch 100 and the second clutch 200 are designed to not be simultaneously in the same engaged configuration. On the other hand, the first and second clutches 100, 200 may be placed at the same time in their disengaged position.

The dual clutch mechanism 10 comprises an input element which is coupled in rotation on the one hand to the input shaft and on the other hand to the entrance web 109 in order to transmit the power—the torque and the speed of rotation—generated at the motor to one of the clutches 100, 200 of the dual clutch mechanism 10. Preferably, the input element of the dual clutch mechanism 10 comprises an entrance hub 130, preferably in rotation about the longitudinal axis O. On its internal elongation, the entrance hub 130 is connected in rotation and/or axially to the input shaft by means of its internal elongation 1301, and optionally via a damping device, not shown, such as a double damping flywheel, for example.

The entrance hub 130 has an external elongation 1302 which is coupled to the entrance web 109, and more particularly to an internal end 1091 of the entrance web 109. The internal end 1091 is situated toward the front AV of the entrance web 109. Preferably, the entrance web 109 and the entrance hub 130 are joined, for example secured by welding and/or by riveting.

The entrance web 109 has an upper end 1092 by which the entrance web 109 is joined in rotation to the first clutch 100. This connection is realized by means of an external axial elongation span 1061 of a first entrance disc holder 106, the first entrance disc holder 106 being joined in rotation to the entrance web 109, preferably by form fitting, such as by fluting in the area of the front end AV of said external axial elongation span 1061.

The first clutch 100 and the second clutch 200 are each controlled by an actuating system 300A, 300B which shall be described further below. Each actuating system 300A, 300B is designed so that it can place the first clutch 100 and the second clutch 200 respectively in any given configuration between the engaged configuration and the disengaged configuration.

The first actuating system 300A is connected to the first clutch 100 by means of the first piston 105, comprising a first radially external portion and a second radially internal portion. In a general manner, the first piston 105 is designed to transmit to the first clutch 100 an axial force E1 exerted parallel to the axis O via its first radially external portion, its second radially internal portion cooperating with a force generator to place the first clutch 100 in one of the configurations described above. In the area of its radially internal portion, the first piston 105 comprises a plurality of first external axial extension spans 1051 which extend axially toward the front AV so as to be able to press the first friction elements 101 against the second friction elements 102 on the one hand, and against an external means of reaction 103 joined mechanically to the entrance web 109 on the other hand. When the first friction elements 101 are moved away from the second friction elements 102, the first clutch 100 is then placed in its disengaged configuration. On the other hand, when the first friction elements 101 are pressed against the second friction elements 102, the first clutch 100 is then placed in its engaged configuration.

The first piston 105 has the shape of a metal sheet which is corrugated and curved toward the front AV at its external radial end.

The first piston 105 comprises an upper radial extension span 1052 situated behind AR the first axial extension spans 1051. The first upper radial extension span 1052 extends radially parallel to the transverse axis T from the first clutch 100 to the internal limit of the second clutch 200.

An intermediate axial extension span 1053 of the first piston 105, parallel to the longitudinal axis O, prolongs the upper radial extension span 1052 of the first piston 105 partially beneath the second clutch 200 and toward the front AV of the dual clutch mechanism 10. The intermediate axial extension span 1053 is situated radially beneath the second clutch 200 and axially toward the rear AR.

Finally, the first piston 105 comprises a first internal radial extension span 1055 connected to the intermediate axial extension span 1053 by means of a first curved zone 1054. The internal radial end of the internal radial extension span 1055 is situated at a distance from a support hub 500 which shall be described further below.

As a nonlimiting example, the first piston 105 may be produced by stamping.

The external means of reaction 103 is joined to the entrance web 109. Preferably, the external means of reaction 103 is connected to the entrance web 109 by means of the entrance disc holder 106.

The external means of reaction 103 has a shape complementary to that of the first or second friction elements 101, 102, so as to allow a coupling by friction of the first and second friction elements 101, 102 when the first actuating system 300A exerts the first axial force E1 toward the front AV in order to place the first clutch 100 in its engaged position. On the contrary, when the first piston 105 is pushed back toward the rear AR by elastic return elements which shall be described below, the first friction elements 101 of the first clutch 100 are then separated from the second friction elements 102, allowing a decoupling of said friction elements and thus enabling the first clutch 100 to be placed in its disengaged configuration.

The first clutch 100 is designed to be coupled in rotation with the first transmission shaft A1 by means of a first exit disc holder 110 forming an output element of said first clutch 100. More particularly, the first exit disc holder 110 is coupled in rotation to the second friction elements 102 by means of an upper end 1101 of the exit disc holder 110. Even more particularly, the first exit disc holder 110 is coupled in rotation to a first exit hub 120 by means of an internal end 1102 of the first exit disc holder 110.

The first exit disc holder 110 has on its external radial periphery an axial elongation 107 which is provided with a toothing designed to cooperate with a complementary toothing on every second friction element 102, and more particularly at the internal radial periphery of every second friction element 102 of the first clutch 100. The axial elongation 107 of the first exit disc holder 110 is situated radially beneath the first 101 and second 102 friction elements of the first clutch 100. The first exit disc holder 110 is thus coupled in rotation by intermeshing with the second friction elements 102 of the first clutch 100.

The first exit hub 120 has axial fluting radially on the inside, designed to cooperate with complementary fluting situated on the first transmission shaft A1, in order to produce a coupling in rotation.

A radial bearing 117 is inserted between the first exit hub 120 and the entrance hub 130 in order to support the radial forces of the entrance hub 130 and/or the entrance web 109 despite the different speeds of rotation at which the input shaft and the first transmission shaft A1 may turn.

In a similar fashion, the second clutch 200 of the dual clutch mechanism 10 has a design similar to that of the first clutch 100.

The second actuating system 300B is connected to the second clutch 200 by means of a second piston 205.

The second piston 205 is situated axially between a second exit disc holder 206 and the second clutch 200.

The second actuating system 300B is connected to the second clutch 200 by means of the second piston 205, comprising a first radially external portion and a second radially internal portion. In a general manner, the second piston 205 is designed to transmit to the second clutch 200 an axial force E2 exerted parallel to the longitudinal axis O via its first radially external portion cooperating with the friction elements 201, 202 of said second clutch 200, and its second radially internal portion cooperating with a force generator to place the second clutch 200 in one of the configurations described above. In the area of its first radially internal portion, the second piston 205 comprises a plurality of second axial extension spans 2051 which extend axially toward the front AV so as to be able to press the first friction elements 201 against the second friction elements 202 on the one hand, and against an internal means of reaction 203 of the second clutch 200, on the other hand. When the first friction elements 201 are moved away from the second friction elements 202, the first clutch 200 is then placed in its disengaged configuration. On the other hand, when the first friction elements 201 are pressed against the second friction elements 202, the second clutch 200 is then placed in its engaged configuration.

The second piston 205 has the shape of a metal sheet which is corrugated and curved toward the front AV at its external radial end.

The second piston 205 comprises an upper radial extension span 2052 situated behind AR the second axial extension spans 2051. The upper radial extension span 2052 of the second piston 205 is inserted axially between a second entrance disc holder 206 and the second clutch 200. The upper radial extension span 2052 extends radially from the second clutch 200 to the inside of the second clutch 200, and more particularly to the outside of an intermediate axial extension span 2063 of the second exit disc holder 206.

An intermediate axial extension span 2053 of the second piston 205 prolongs toward the front AV and parallel to the axis O the upper radial extension span 2052 of the second piston 205. The intermediate axial extension span 2053 is situated radially inside the second clutch 200 and outside the intermediate axial extension span 2063 of the second exit disc holder 206.

Finally, the second piston 205 comprises a plurality of second internal radial extension spans 2055 connected to the intermediate axial extension span 2053 by means of a curved zone 2054 of the second piston 205. The curved zone 2054 of the second piston 205 has the shape of an S in the transverse section plane illustrated in FIG. 2.

As a nonlimiting example, the second piston 205 may be obtained by stamping.

The second exit disc holder 206 of the dual clutch mechanism 10 comprises an external axial elongation portion 2061 oriented toward the front AV. The external axial elongation portion 2061 of the second exit disc holder 206 is situated radially on the outside of the second clutch 200, and it extends axially along the entire length of said second clutch 200. The second exit disc holder 206 also comprises an upper radial extension span 2062 situated behind AR the external axial elongation portion 2061. The upper radial extension span 2062 extends radially from the outside of the second clutch 200 to the inside of the second clutch 200.

An intermediate axial extension span 2063 of the second exit disc holder 206 prolongs toward the front AV and parallel to the axis O the upper radial extension span 2062 of the second exit disc holder 206. The intermediate axial extension span 2063 is situated radially beneath the second axial span 2053 of the second piston 205.

Finally, the second exit disc holder 206 comprises an internal radial extension span 2065 connected to the intermediate axial extension span 2063 by means of a curved zone 2064. The internal radial end of the internal radial extension span 2065 is firmly secured against the support hub 500, for example by welding.

Thus, the first exit disc holder 106 and the second exit disc holder 206 are coupled in rotation by means of the support hub 500: each exit disc holder 106, 206 is respectively joined firmly to said support hub 500 by means of its internal radial end.

The internal means of reaction 203 is secured to the second entrance disc holder 206, more particularly in the area of its external axial elongation portion 2061 to which the internal means of reaction 203 is secured by any means, such as by welding or riveting. Alternatively, the internal means of reaction 203 and the second entrance disc holder 206 are made from the same material. The internal means of reaction 203 has a shape complementary to that of the first or second friction elements 201, 202, so as to allow a coupling by friction of the first and second friction elements 201, 202 when the second actuating system 300B exerts an axial force E2 toward the front AV in order to place the second clutch 200 in its engaged position. On the contrary, when the second piston 205 is pushed back toward the rear AR by elastic return elements which shall be described below, the first friction elements 201 of the second clutch 200 are then separated from the second friction elements 202, allowing a decoupling of said friction elements 201, 202 and thus enabling the second clutch 200 to be placed in its disengaged configuration.

The second clutch 200 is designed to be coupled in rotation with the second transmission shaft A2 by means of a second exit disc holder 210 forming an output element of said second clutch 200. More particularly, the second exit disc holder 210 is coupled in rotation to the second friction elements 202 by means of an upper end 2101 of the second exit disc holder 210. The second exit disc holder 210 is coupled in rotation to a second exit hub 220 by means of an internal end 2102 of the second exit disc holder 210.

The second exit disc holder 210 has on its external radial periphery an axial elongation 207 which is provided with a toothing designed to cooperate with a complementary toothing on every second friction element 202, and more particularly at the internal radial periphery of every second friction element 202 of the second clutch 200. The second exit disc holder 210 is thus coupled in rotation by intermeshing with the second friction elements 202 of the second clutch 200.

For this purpose, the second exit hub 220 has axial fluting in the area of its internal end 2102, designed to cooperate with complementary fluting situated on the second transmission shaft A2, in order to produce a coupling in rotation.

Furthermore, a radial bearing 116 is inserted between the first exit disc holder 110 and the second exit disc holder 210 in order to be able to transmit an axial force between the two exit disc holders 110, 210 which may turn at different speeds when the first and second clutches 100, 200 are placed in a different configuration.

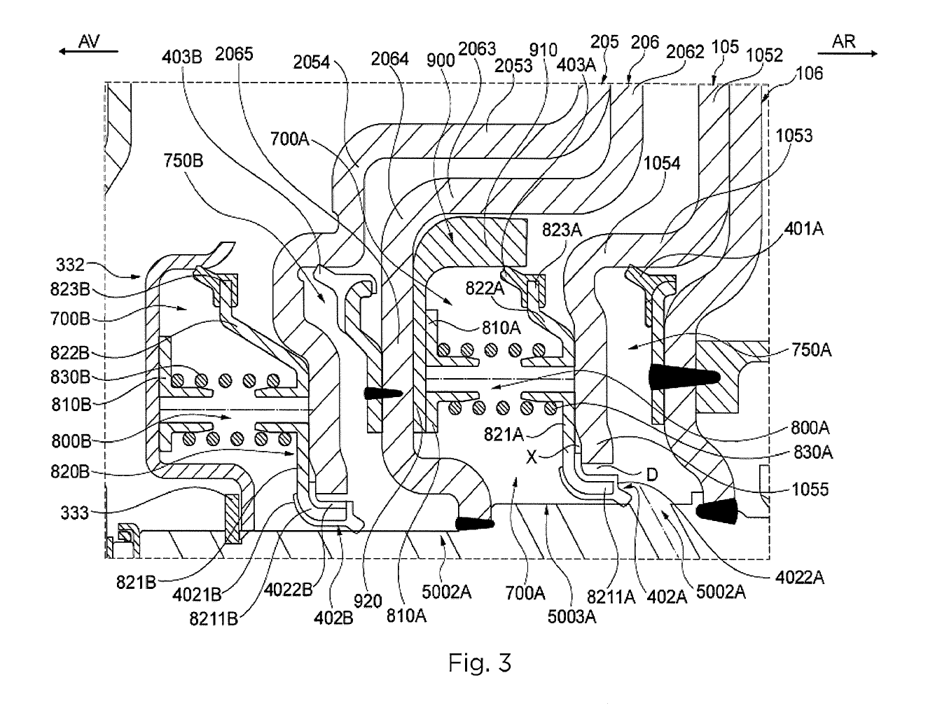

Preferably, and as is illustrated more particularly in FIG. 3, each actuating system 300A, 300B further comprises an elastic return device 800A, 800B designed to generate an axial forced oriented toward the rear AR and opposing the displacement of the corresponding piston 105, 205 when it is pushed toward the front AV in order to engage the corresponding clutch 100, 200.

In particular, the first elastic return device 800A associated with the first clutch 100 comprises:
a first annular piece 810A designed to bear against a support face of the dual clutch mechanism 10, and more particularly in the area of the internal radial extension span 2065 of the second entrance disc holder 206;
a second annular piece 820A designed to bear against the first piston 105, and more particularly in the area of the internal radial extension span 1055 of said first piston 105;
a plurality of elastic elements 830A extending between the first annular piece 810A and the second annular piece 820A of the first elastic return device 800A. In an advantageous manner, the plurality of elastic elements 830A are of the helicoidal spring type.

In a comparable manner, the second elastic return device 800B associated with the second clutch 200 comprises:
a first annular piece 810B designed to bear against a support face of the dual clutch mechanism 10, and more particularly in the area of a liner plate 332 which is blocked axially toward the front AV by an axial locking ring 333 housed in a circumferential groove of the external face of the support hub 500;
a second annular piece 820B designed to bear against the second piston 205, and more particularly in the area of the internal radial extension span 2055 of said second piston 205;
a plurality of elastic elements 830B extending between the first annular piece 810B and the second annular piece 820B of the second elastic return device 800B. In an advantageous manner, the plurality of elastic elements 830B are of the helicoidal spring type.

According to the invention taken in its second aspect, each actuating system 300A, 300B of the dual clutch mechanism 10 illustrated in FIGS. 2 to 4 comprises:
a control chamber 750A, 750B designed to receive a pressurized fluid;
a balancing chamber 700A, 700B bounded in part by a piston, the piston being axially movable and radially bounding the control chamber toward the outside by an axial extension span, said piston extending radially to the outside from said control chamber in order to engage or disengage the clutch under the effect of the pressurized fluid contained in the control chamber;
an elastic return device 800A, 800B as previously described, said elastic return device being housed in the corresponding balancing chamber 700A, 700B and extending between the piston 105, 205 and the corresponding support face of the dual clutch mechanism 10.

The control chamber 750A of the first actuating system 300A is designed to receive a certain volume of hydraulic fluid under pressure in order to generate the axial force E1 on the internal radial extension span 1055 of the first piston 105 and to thus place the first clutch 100 in one of the previously described configurations. The pressurized hydraulic fluid is advantageously routed by means of high-pressure fluid circulation lines passing at least partly through the support hub 500 and emerging in the control chamber 750A of the first actuating system 300A in the area of an external face of said support hub 500 by a feed line 5002A.

The control chamber 750A of the first actuating system 300A is thus advantageously bounded:
radially toward the inside, by a portion of the support hub 500;
axially toward the rear AR, by an internal radial elongation portion of the first entrance disc holder 106;
radially toward the outside, by the intermediate axial extension span 1053 and the first curved zone 1054 of the first piston 105; and
axially toward the front AV, by the internal radial extension span 1055 of the first piston 105.

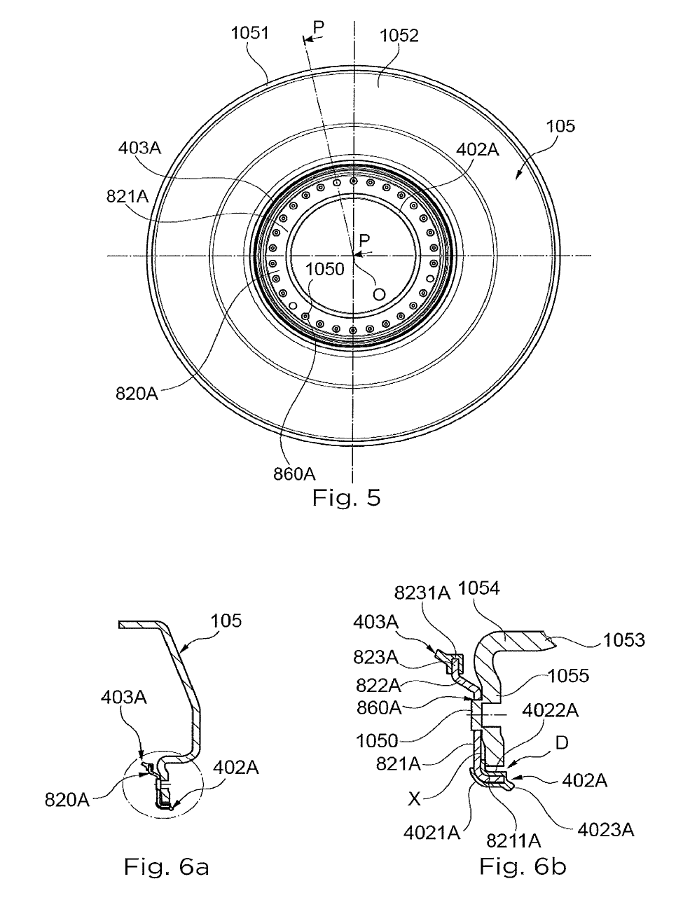

It will also be noted that the tightness of the control chamber 750A of the first actuating system 300A is guaranteed by the presence of:
a first gasket 401A situated between the internal radial portion of the first entrance disc holder 106 and the intermediate axial extension span 1053 of the first piston 105;
a second gasket 402A situated axially between the internal radial end of the internal radial extension span 1055 of the first piston 105 and the support hub 500. According to the invention taken in its first aspect, the second gasket 402A is advantageously carried by the elastic return device 800A of the first actuating system 300A, as described in particular by FIG. 1 for a first embodiment, and as shall be described below through FIGS. 5 and 6.

The balancing chamber 700A of the first actuating system 300A is designed to receive a certain volume of hydraulic fluid making it possible to lubricate the first elastic return device 800A housed in said balancing chamber 700A. The lubrication fluid is advantageously routed by means of low-pressure fluid circulation lines passing axially through the support hub 500 and emerging in the balancing chamber 700A in the area of an external face of said support hub 500 by a feed line 5003A.

The balancing chamber 700A of the first actuating system 300A is thus advantageously bounded:
radially toward the inside, by a portion of the support hub 500;
axially toward the rear AR, by the internal radial extension span 1055 of the first piston 105;
radially toward the outside, by the intermediate axial extension span 2063 of the second exit disc holder 206; and
axially toward the front AV, by the internal radial extension span 2065 of the second exit disc holder 206.

It will also be noted that the tightness of the balancing chamber 700A of the first actuating system 300A is guaranteed by the presence of:
a third gasket 403A which extends between the second annular piece 820A of the first elastic return device 800A and an external cylindrical span 910 of a diameter reducer 900 housed in the balancing chamber 700A and forming an internal jacketing of said balancing chamber 700A; and
the second gasket 402A situated axially between the internal radial end of the internal radial extension span 1055 of the first piston 105 and the support hub 500. According to the invention taken in its first aspect, the second gasket 402A is carried by the elastic return device 800A of the first actuating system 300A, as described in particular by FIG. 1 for a first embodiment, and as shall be described below through FIGS. 5 and 6.

In a comparable manner, the control chamber 750B of the second actuating system 300B is designed to receive a certain volume of hydraulic fluid under pressure in order to generate the axial force E2 on the internal radial extension span 2055 of the second piston 205 and to thus place the second clutch 200 in one of the previously described configurations. The pressurized hydraulic fluid is advantageously routed by means of high-pressure fluid circulation lines passing at least partly through the support hub 500 and emerging in the control chamber 750B of the second actuating system 300B in the area of an external face of said support hub 500 by a feed line 5002B.

The control chamber 750B of the second actuating system 300B is thus advantageously bounded:
radially toward the inside, by a portion of the support hub 500;
axially toward the rear AR, by the internal radial extension span 2065 of the second entrance disc holder 206;
radially toward the outside, by the curved zone 2054 of the second piston 205; and
axially toward the front AV, by the radial extension span 2055 of the second piston 205.

It will also be noted that the tightness of the control chamber 750B of the second actuating system 300B is guaranteed by the presence of:
a first gasket 401B situated between the internal radial extension span 2065 of the second entrance disc holder 206 and the curved zone 2054 of the second piston 205;
a second gasket 402B situated axially between the internal radial end of the internal radial extension span 2055 of the second piston 205 and the support hub 500. According to the invention taken in its first aspect, the second gasket 402B is advantageously carried by the elastic return device 800B of the second actuating system 300B, as described in particular by FIG. 1 for a first embodiment, and as shall be described below through FIGS. 5 and 6.

The balancing chamber 700B of the second actuating system 300B is designed to receive a certain volume of hydraulic fluid making it possible to lubricate the second elastic return device 800B housed in said balancing chamber 700B. The lubrication fluid is advantageously routed by means of low-pressure fluid circulation lines passing axially through the support hub 500 and emerging in the balancing chamber 700B of the second actuating system 300B in the area of an external face of said support hub 500 by a feed line, not visible in FIGS. 2 to 4.

In addition, the low-pressure fluid circulation lines comprise a main feed line 5001 situated in the area of the axial front end AV of the support hub 500. The main feed line has a radial orientation and makes it possible to establish a fluidic communication of the lubricating fluid in line with the clutches 100, 200 in order to improve their lubrication during the operation of the dual clutch mechanism 10 according to the second aspect of the invention.

The balancing chamber 700B of the second actuating system 300B is thus advantageously bounded:
radially toward the inside, by a portion of the support hub 500;
axially toward the rear AR, by the internal radial extension span 2055 of the second piston 205;
radially toward the outside and axially toward the front AV, by the liner plate 332.

It will also be noted that the tightness of the balancing chamber 700B of the second actuating system 300B is guaranteed by the presence of:
a third gasket 403B which extends between the second annular piece 820B of the second elastic return device 800B and an external cylindrical span of the liner plate 332; and
the second gasket 402B situated axially between the internal radial end of the internal radial extension span 2055 of the second piston 105 and the support hub 500. According to the invention taken in its first aspect, the second gasket 402B is carried by the elastic return device 800B of the second actuating system 300B, as described in particular by FIG. 1 for a first embodiment, and as shall be described below through FIGS. 5 and 6.

It will be understood at this stage of the description that, under the effect of the pressurized fluid filling the control chamber 750A, 750B of one of the actuating systems 300A, 300B, the first and second force transmission elements 105, 205 are displaced axially toward the front AV following the axial forces E1, E2 in order to place the first 100 and second 200 clutches, respectively, in their engaged configuration. In addition, under the effect of the first and second elastic return devices 800A, 800B housed in the corresponding balancing chambers 700A, 700B, the force transmission elements 105, 205 are pushed back toward the rear AR in order to place the first 100 and second 200 clutches, respectively, in their disengaged configuration.

The actuating systems 300A, 300B thus form force generators for the force transmission elements 105, 205 of the corresponding clutches 100, 200.

Referring to FIGS. 5 and 6, one of the elastic return devices 800 mounted on one of the pistons 105, 205, seen from one of the balancing chambers 700 of the clutch mechanism 10 according to the second aspect of the invention, will now be described in further detail.

In order to facilitate the understanding of FIGS. 5 and 6, we shall refer to the first elastic return device 800 mounted on the first piston 105, but the technical characteristics described hereafter apply of course to the second elastic return device mounted on the second piston 205.

The second annular piece 820A of the first elastic return device 800A bears axially against the first piston 105. More particularly, a radial elongation edge 821A of the second annular piece 820A bears axially against the internal radial extension span 1055 of the first piston 105. In particular, the second annular piece 820 is—by means of its radial elongation edge 821A—bearing against a face of the internal radial extension span 1055 of the first piston 105, oriented axially opposite the plurality of elastic elements 830.

The second annular piece 820 is coaxial by the axis O with the first piston 105. The second annular piece 820A is formed by the radial elongation edge 821A which extends from an internal peripheral end 8211A to a slanting intermediate span 822A which extends axially in a direction opposite the first piston 105, toward the inside of the balancing chamber. The slanting intermediate span 822A is prolonged radially toward the outside by an external radial extension span 823A which carries, in the area of its external end 8231A, another gasket 403A, known as the third gasket 403A.

The internal peripheral end 8211A of the second annular piece 820A is angled and extends substantially perpendicular to the radial elongation edge 821A in a direction opposite that of the upper radial end 8231A. More particularly, the internal peripheral end 8211A forms an elbow which extends axially in the direction of the first piston 105. Radially, the internal peripheral end 8211A is situated inside the first piston 105, such that there exists a radial play between the angled internal peripheral end 8211A of the second annular piece 820A and an internal radial end of the internal radial extension span 1055 of the first piston 105.

The second annular piece 820A comprises at its internal peripheral end 8211A a gasket 402A, known as the second gasket 402A. The second gasket 402A is advantageously formed by a first seal 4021A situated axially opposite the first piston 105 in relation to the second annular piece 820A, and a second seal 4022A which is situated on the side of said first piston 105. Thus, the second gasket 402A is secured firmly to the second annular piece 820A, more particularly in the area of its internal peripheral end 8211A, for example by press fitting, by vulcanization, by overmoulding or by gluing.

In an advantageous manner, the second seal 4022A of the second gasket 402A extends on the radial elongation edge 821A of the second annular piece 820A, radially beyond the first seal 4021A.

The second gasket 402A also has a lip 4023A which extends at the same time radially inside the internal peripheral end 8211A of the second annular piece 820A and axially in a direction opposite the external radial end 8231A in relation to the radial elongation edge 821A of the second annular piece 820A.

Radially, the portion of the second seal 4022A of the second gasket 402A situated on the angled portion of the internal peripheral end 8211A of the second annular piece 820A is situated inside the first piston 105, so that there exists a radial play D between the second seal 4022A and the internal radial end of the internal radial extension span 1055 of the first piston 105.

On the other hand, axially, the portion of the second seal 4022A of the second gasket 402A situated on the radial elongation edge 821A of the second annular piece 820A bears against the first piston 105. Further preferably, the portion of the second seal 4022A of the second gasket 402A situated on the radial elongation edge 821A of the second annular piece 820A is clamped between the internal radial extension span 1055 of the first piston 105 and the radial elongation edge 821A of the second annular piece 820A. To do this, an axial space X, measuring along an axial direction, is less than or equal to the thickness of the second seal 4022A of the second gasket 402A. In the example illustrated in FIG. 6B, the internal radial end of the internal radial extension span 1055 of the first piston 105 is axially deformed in the direction opposite the second annular piece 820A in order to produce such a clamping. The gasket is thus axially prestressed between the second annular piece and the corresponding piston.

The clamping of the second seal 4022A of the second gasket 402A between the internal radial extension span 1055 of the first piston 105 and the radial elongation edge 821A of the second annular piece 820A may be realized by any other means, for example by a local machining of a face of the internal radial extension span 1055 of the first piston 105 situated opposite the second annular piece 820A. Alternatively, the clamping may also be achieved by a local deformation of a face of the radial extension edge 821A of the second annular piece 820A situated opposite the first piston 105, or else by machining.

In an advantageous manner, the first elastic return device 800A comprises a centring means 860A cooperating with a complementary centring means 1050 situated on the first piston 105, in order to make said first elastic return device 800A coaxial with said first piston 105. More particularly, the centring means 860A of the first elastic return device 800A is formed by an axial opening 860A situated on the radial elongation edge 821A, and the complementary centring means 1050 of the first piston 105 is formed by a cylindrical span of axial extension 1050 carried by a face of the first piston 105 situated opposite the second annular piece 820A.

Preferably, the second annular piece 820A comprises a plurality of axial openings 860A collectively forming the centring means, said plurality of axial openings 860A being distributed at regular angles about the longitudinal axis O. In addition, the first piston 105 preferably comprises a plurality of cylindrical spans of axial extension 1050, said plurality of cylindrical spans 1050 being distributed at regular angles about the longitudinal axis O.

The axial opening 860A of the second annular piece 820A advantageously has a diameter greater than or equal to the diameter of the cylindrical span 1050 of the first piston 105, so that said cylindrical span 1050 cooperates with the axial opening 860A by press fitting, preferably with no play, optionally by force fitting.

The cylindrical span 1050 can be produced by a specific machining of the first piston 105, or by stamping, for example.

Of course, the invention is not limited to the examples just described and many adjustments can be made to these examples without departing from the scope of the invention. In particular, the various characteristics, forms, variants and embodiments of the invention may be associated with one another in various combinations as long as they are not mutually incompatible or exclusive. In particular, all the variants and embodiments described above can be combined with each other.

1. Elastic return device for a wet clutch mechanism, said elastic return device being designed to generate a force opposing a piston placed in movement by an actuating system of a clutch of the clutch mechanism, said elastic return device comprising:
a first annular piece designed to bear against a support face of the clutch mechanism;
a second annular piece designed to bear against the piston of the clutch mechanism;
a plurality of elastic elements extending between the first annular piece and the second annular piece;
wherein the second annular piece comprises at its internal peripheral end a gasket, and wherein the second annular piece bears against a face of the piston oriented axially opposite the plurality of elastic elements.

2. Elastic return device according to claim 1, wherein the internal peripheral end of the second annular piece is formed by an angled end portion.

3. Elastic return device according to claim 2, wherein the angled end portion of the second annular piece extends axially in a direction opposite that of the first annular piece.

4. Elastic return device according to claim 1, wherein the gasket is fitted onto the internal peripheral end of the second annular piece.

5. Elastic return device according to claim 1, wherein the gasket extends along a radial elongation edge of the second annular piece.

6. Elastic return device according to claim 5, wherein the gasket comprises a first seal and a second seal, the second seal extending radially beyond the first seal on the second annular piece.

7. Elastic return device according to claim 1, wherein the gasket has a lip.

8. Elastic return device according to claim 1, wherein the plurality of elastic elements is of the helicoidal spring type.

9. Clutch mechanism designed to be installed between a motor and a transmission of a vehicle, said clutch mechanism comprising:
a clutch in rotation about an axis of rotation;
an actuating system designed to engage or disengage the clutch, said actuating system comprising:
a control chamber designed to receive a pressurized fluid;
a balancing chamber bounded in part by a piston, the piston being axially movable and radially bounding the control chamber toward the outside by an axial extension span, said piston extending radially to the outside from said control chamber in order to engage or disengage the clutch under the effect of the pressurized fluid contained in the control chamber;
an elastic return device claim 1, said elastic return device being housed in the balancing chamber and extending between the piston and a lateral face of the balancing chamber.

10. Clutch mechanism according to claim 9, comprising:
an elastic return device for a wet clutch mechanism, said elastic return device being designed to generate a force opposing a piston placed in movement by an actuating system of a clutch of the clutch mechanism, said elastic return device comprising:
a first annular piece designed to bear against a support face of the clutch mechanism;
a second annular piece designed to bear against the piston of the clutch mechanism;
a plurality of elastic elements extending between the first annular piece and the second annular piece;
wherein the second annular piece comprises at its internal peripheral end a gasket, and wherein the second annular piece bears against a face of the piston oriented axially opposite the plurality of elastic elements,
wherein the internal peripheral end of the second annular piece is formed by an angled end portion, and
wherein the angled end portion of the elastic return device extends in a radial direction, said angled end portion being situated radially between an internal end of the piston and a support hub of the clutch mechanism.

11. Clutch mechanism according to claim 10, wherein the gasket of the elastic return device is at least partly bearing against the support hub and against the piston.

12. Clutch mechanism according to claim 11, comprising:
an elastic return device for a wet clutch mechanism, said elastic return device being designed to generate a force opposing a piston placed in movement by an actuating system of a clutch of the clutch mechanism, said elastic return device comprising:
a first annular piece designed to bear against a support face of the clutch mechanism;
a second annular piece designed to bear against the piston of the clutch mechanism;
a plurality of elastic elements extending between the first annular piece and the second annular piece;
wherein the second annular piece comprises at its internal peripheral end a gasket, and wherein the second annular piece bears against a face of the piston oriented axially opposite the plurality of elastic elements,
wherein the gasket extends along a radial elongation edge of the second annular piece,
wherein the gasket comprises a first seal and a second seal, the second seal extending radially beyond the first seal on the second annular piece, and
wherein, in the area of the radial elongation edge of the second annular piece of the elastic return device, the second seal of the gasket is interposed between said second annular piece and the piston of the clutch mechanism.

13. Clutch mechanism according to claim 12, wherein an axial space is formed between the piston and the second annular piece of the elastic return device, along which piece the second seal of the gasket extends, the axial space, taken along a radial direction, being less than or equal to the thickness of the second seal of the gasket.

14. Clutch mechanism according to claim 9, wherein the elastic return device comprises a centring means formed by at least one axial opening cooperating with at least one complementary cylindrical span of axial extension and formed on a face of the piston opposite the elastic return device.

15. Clutch mechanism according to claim 9, wherein the lateral face of the balancing chamber against which the elastic return device bears is formed by a face of an entrance disc holder of the clutch mechanism situated opposite the piston.

16. Clutch mechanism according to claim 9, wherein the clutch mechanism is of the dual clutch type comprising a first clutch driven by a first actuating system and a second clutch driven by a second actuating system.

17. Elastic return device according to claim 2, wherein the gasket is fitted onto the internal peripheral end of the second annular piece.

18. Elastic return device according to claim 2, wherein the gasket extends along a radial elongation edge of the second annular piece.

19. Elastic return device according to claim 2, wherein the gasket has a lip.

20. Elastic return device according to claim 2, wherein the plurality of elastic elements is of the helicoidal spring type.
